(19) United States
(12) Patent Application Publication
(10) Pub. No.: US 2007/0040876 A1
(43) Pub. Date: Feb. 22, 2007

(54) Methods and apparatus for transferring information between a consummable item and a printing device using radio frequency

(75) Inventors: Frank Edward Anderson, Sadieville, KY (US); Michael Clark Campbell, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/208,814

(22) Filed: Aug. 22, 2005

(51) Int. Cl. B41J 2/175

(52) U.S. Cl. 347/86

(57) ABSTRACT

An ink tank for an inkjet printing device having a housing configured to connect to an inkjet printing device and a reservoir for containing ink disposed within the housing. The housing includes a plurality of faces. The ink tank also includes a RF linking device positioned along one of the largest faces of the faces. A system for exchanging information between a consumable item and an printing device includes a printing device and a consumable item. The printing device includes a housing and a RF linking device disposed along the printing device housing. The consumable item is detachably connected to the printing device and includes a RF linking device positioned along a substantially vertical face of the consumable item.

### FIELD OF THE INVENTION

The present invention generally relates to printing systems. More particularly, the present invention relates to a consumable item such as an ink tank for an external printing device such as an inkjet printer, wherein the consumable item and the external printing device are configured to transfer information between one another using radio frequency.

### BACKGROUND OF THE INVENTION

Conventional printing devices include one or more consumable items that may be replaced once fully consumed during the printing operations. By way of example, inkjet printing is a conventional technique by which printing is normally accomplished without contact between the printing apparatus and the substrate, or medium, on which the desired print characters are deposited. Conventional inkjet printing devices such as a fax, printer, photo printer, all-in-one device, plotter, or any other device incorporating inkjet printing technology typically include one or more consumable items such as ink tanks in which ink is stored and ink printheads in which ink is dispensed. In one embodiment of the inkjet printing device, the ink tank and printhead are generally placed within a movable print carriage of the inkjet device. In another embodiment, the ink tank is fixedly connected to the inkjet device while the printhead is connected to the movable print carriage. In still another embodiment of the inkjet printing device, both the printhead and ink tank are combined into single unit print cartridge connected to a movable carriage.

It is desirable to transmit and/or receive information and/or control signals between the consumable item and the printing device. For example, it may be desirable to transmit the brand of the ink tank, type of ink (e.g., color, viscosity, etc.), and amount of ink from the ink tank to the inkjet printer to ensure the ink tank is compatible with the inkjet printer. In addition, such information allows the printer to know what type of ink is in each tank in order to operate properly and/or optimally. With such information, the printer may adjust settings to account for the ink's properties. Further, the ink tank may receive control signals from the printer in order to dispense or receive ink at the appropriate times.

Typically, such information and control signal transmission has been accomplished through a hard wire and/or contact connection between the consumable and the printer. Such connections generally were problematic. For example, when the consumable is replaced, the electrical connections did not always reconnect completely and/or correctly, thus providing for incomplete electrical connections. Incomplete electrical connections would either cause the system to fail or provide incorrect data transfer. In addition, the hard-wired connections tended to restrict and get in the way of the movement of a carriage if the consumable is mounted to the carriage of the printer.

Accordingly, there is a need for a consumable item for a printing device capable of using radio frequency.

### SUMMARY OF THE INVENTION

Accordingly, the present invention is intended to address and obviate problems and shortcomings and otherwise improve previous information links between consumable items and printing devices.

One exemplary embodiment of the present invention is an ink tank for an inkjet printing device. The ink tank includes a housing configured to connect to the inkjet printing device. The ink tank housing has a plurality of faces and a reservoir for containing ink disposed within it. In addition, the ink tank includes a RF linking device positioned along one of the largest faces of the faces.

Another exemplary embodiment of the present invention is a system for exchanging information between a consumable item and a printing device. The printing device includes a housing and a RF linking device disposed along the printing device housing. The consumable item is detachably connected to the printing device and includes a second RF linking device positioned along a substantially vertical face of the item.

An exemplary method of the present invention includes a method of linking a consumable item with a printer using RF. The method includes providing a consumable item for a printer and placing a RFID tag having an antenna along a face of the consumable item such that the area of the antenna is maximized.

### BRIEF DESCRIPTION OF THE DRAWINGS

While the specification concludes with claims particularly pointing out and distinctly claiming the invention, it is believed the same will be better understood from the following description taken in conjunction with the accompanying drawings in which:

FIG. 1 is a perspective schematic representation of an exemplary embodiment of the inkjet printing having a RF linking system according to the present invention;

FIG. 2 is a schematic representation of an ink tank with a RF linking device according to the present invention and RF linking device of the printing device illustrated in FIG. 1;

FIG. 3 is a schematic representation of the RF linking devices illustrated in FIG. 2; and

FIG. 4 is a side elevational, schematic representation of the ink tank and RF linking device of the printing device illustrated in FIG. 2.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

Reference will now be made in detail to various embodiments of the invention, examples of which are illustrated in the accompanying drawings, wherein like numerals indicate similar elements throughout the views.

The present invention provides a consumable item for an external printing device, wherein the consumable item and the external device are configured to transfer and receive information to and from one another via radio frequency. While the exemplary embodiments illustrated herein describe ink tanks for inkjet printer technology, as will be apparent to those of ordinary skill in the art the present invention may be employed in other consumable items for print technologies such as printheads for inkjet printers, print cartridges for inkjet printers, toner cartridges for laser jet printers, ink tanks for fax, photo printers, all-in-one devices, or plotters, or any other device incorporating printing technology.

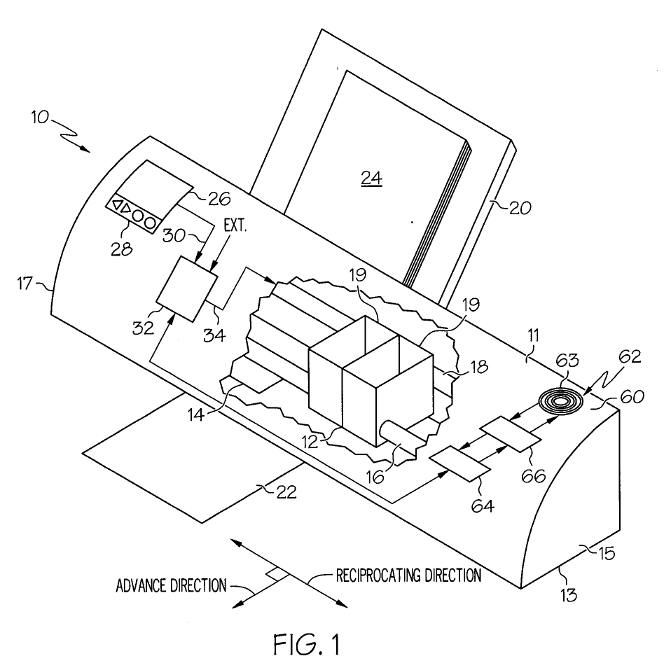

Referring to FIGS. 1-4, an exemplary embodiment of a consumable item (e.g., ink tank 40) having an RFID tag 50 for an external printing device (e.g., inkjet printer 10) of the present invention is shown. Inkjet printer 10 may include a carriage 12 having one or more positions for containing one or more ink tanks 40. The carriage 12 reciprocates (in accordance with an output 34 of a controller 32) along a shaft 16 above a print zone 14 by a motive force supplied to a drive belt 18 as is well known in the art. The reciprocation of the carriage 12 occurs relative to a print medium, such as a sheet of paper 24 that advances in the printer 10 along a paper path from an input tray 20, through the print zone 14, to an output tray 22. As one skilled in the art will appreciate, any carriage movement mechanism may be utilized in the present invention.

While in the print zone, the carriage 12 reciprocates in the Reciprocating Direction generally perpendicular to the paper 24 being advanced in the Advance Direction as shown by the arrows. Ink drops from a reservoir 44 (discussed later herein) of ink tank 40 are caused to be ejected from a heater chip (not shown) of a printhead (not shown) at such times pursuant to commands of a printer microprocessor or other controller 32. The timing of the ink drop emissions corresponds to a pattern of pixels of the image being printed. Often times, such patterns become generated in devices electrically connected to the controller 32 (via external input) that reside externally to the printer and include, but are not limited to, a computer, a scanner, a camera, a visual display unit, a personal data assistant, or other. While the exemplary embodiment illustrated herein has been described with reference to thermal inkjet printhead technology, as will be apparent to those of ordinary skill in the art the present invention may be employed in or in combination with inkjet printheads which employ other technologies such as pressurized nozzles, electrostatic fields and/or piezo-electric elements.

Inkjet printer 10 may also include a control panel 26 having a user selection interface 28 as found in conventional printers. Control panel 26 may function as an input 30 to controller 32 to provide additional printer capabilities and robustness. Such a control panel is known to one of ordinary skill in the art and need not be described in detail herein.

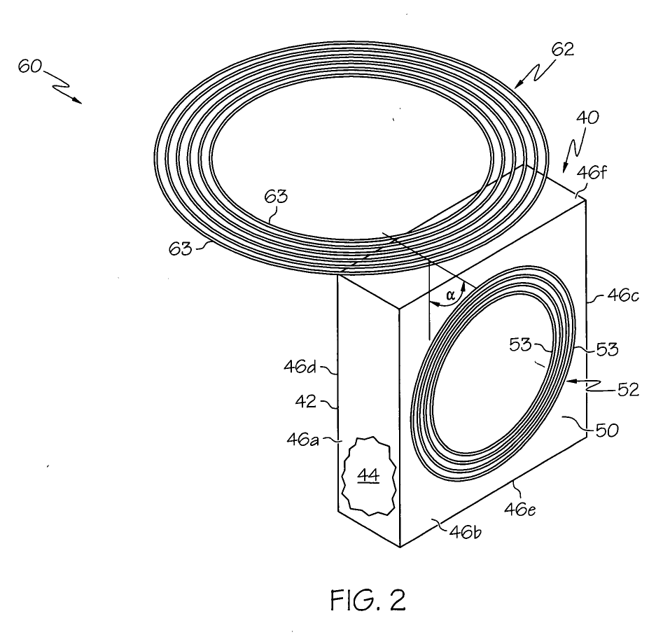

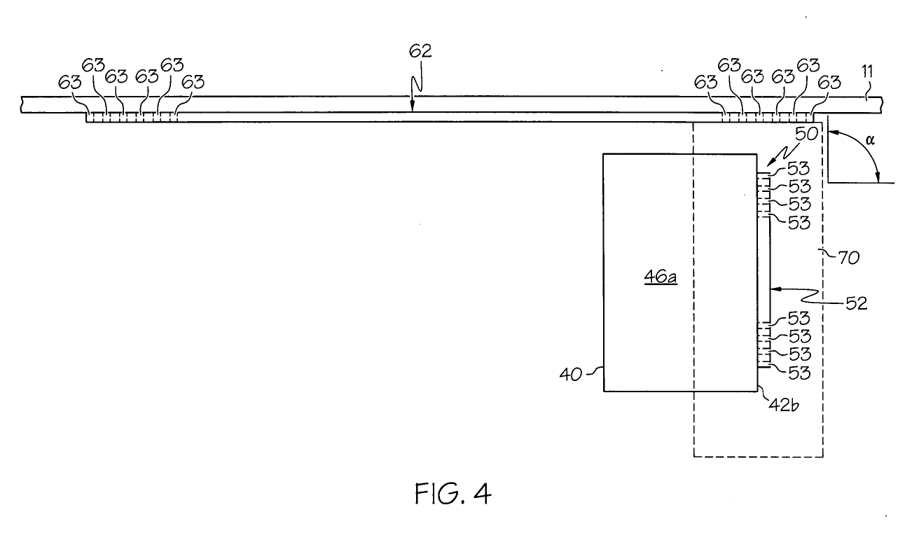

Ink tank 40 may be a variety of conventional receptacles for containing ink for use with a conventional external printing device as known to or yet-to-be developed by one of ordinary skill in the art. For example, ink tank 40 may be an ink tank for an inkjet printer or a print cartridge (i.e., a thermal printhead and tank combination). Ink tank 40 may include a housing 42 having a plurality of faces 46a, 46b, 46c, 46d, 46e, and 46f. The exemplary embodiment of ink tank 40 shown in FIGS. 2 and 4 comprises a substantially rectangular prism shape. It is understood that housing 42 and reservoir 44 may comprise a variety of shapes, sizes, and configurations without departing from the spirit and scope of the present invention. Housing 42 contains reservoir 44, which is configured to hold ink for dispensing during a printing operation. In addition, ink tank 40 may comprise any other components found in conventional ink tanks, including but not limited to wicking material, thermal inkjet printheads, heater chips, nozzles, pressurized nozzles, electrostatic fields and/or piezo-electric elements, which are well known to one of ordinary skill in the art and need not be described herein.

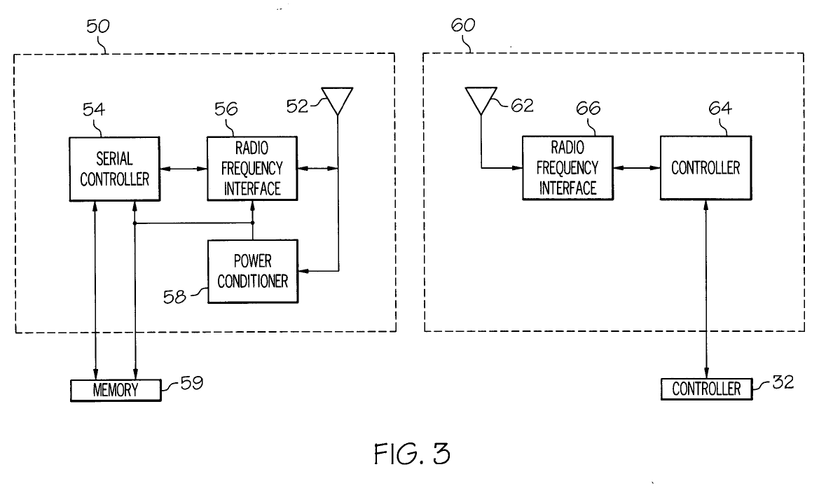

Ink tank 40 may include a radio frequency (“RF”) linking device 50 positioned along one of its faces (46a-46f). RF linking device 50 may comprise any conventional device capable of receiving and transmitting information and/or control signals, such as a RFID tag, RF transceiver, etc. An illustrative example of an RFID tag that is known in the art is Texas Instruments “Tag-it”™ HF-I transponder inlays, part number RI-I11-112A. With reference to FIG. 3, RF linking device 50 may include an antenna 52, a controller 54 (e.g., transceiver chip), a RF interface, a power conditioner 58, and/or a memory 59. In the exemplary embodiment, controller 54 is connected to RF interface 56, which is connected to antenna 52. In addition, memory 59 is connected to the controller and RF interface while all of these components are connected to power conditioner 58.

Antenna 52 may comprise a loop 53 of conductor material, forming a periphery of antenna 52. In the exemplary embodiment, RF linking device 50 is a RFID tag, which is positioned along one of the ink tank's substantially vertically faces (e.g., 46b). Face 46b, in this exemplary embodiment is one of the ink tank's largest faces relative to its other faces (46a, 46c, 46e, and 46f). Linking device 50 may be placed on one of the largest faces (e.g., 46b) of ink tank 40 in order to maximize the area of loop 53 of antenna 52. Such maximization of the antenna's area increases and/or improves the signal reception/transmission of the antenna 52. It is understood that linking device 50 and thus antenna 52 may be positioned along one of ink tank's 40 other faces 46a, 46 c, 46d, 46e, and 46f without departing from the spirit and scope of the present invention.

In the exemplary embodiment, ink tank 40 is configured to be mounted on a scanning carriage 12 of inkjet printer 10. It is understood that ink tank 40 may also be configured to be mounted in a stationary position to either the printer or remote of the printer A second RF linking device 60 may be positioned on printer 10 to transmit and receive signals and information from RF linking device 50. RF linking device 50 may comprise any conventional device capable of receiving and transmitting information and/or control signals. RF linking device 60 may include an antenna 62, a controller 64 (e.g., transceiver chip), and/or a RF interface. In the exemplary embodiment, controller 64 is connected to RF interface 66, which is connected to an antenna 62. In addition, RF controller 64 is connected to printer controller 32. Antenna 62 may be formed from a loop 63 of conductor material, forming a periphery of antenna 62.

Antenna 62 may be integrated into a printed circuit board (not shown) of controller 64 such that antenna 62 and controller 64 are a single unit. This integrated unit (e.g., antenna 62, controller 64, and RF interface) reduces electrical noise in the system, avoids unnecessary electromagnetic emissions, and achieves a low cost system. The integrated unit would communicate to a controller in the printer via a serial interface. Some examples of serial interfaces may include, but are not limited to, are RS232, I²C bus or serial peripheral interface (SPI). In addition, the integrated antenna and controller has another advantage in meeting various worldwide electromagnetic compatibility (EMC) standards for intentional radiators. This is advantageous because if there was a printer transceiver qualification needed to market the printer in a particular country, the integrated unit could be independently qualified for use in that country. Therefore, the integrated antenna/controller could be used in several future printers without re-qualification for each new printer.

Alternatively, antenna 62 may be mounted remotely from controller 64. The remote mounting of antenna 62 may be necessary to package the controller and antenna into the printing device (i.e., there may not be enough room to integrate the antenna 62 and controller 64). If antenna 62 is remotely mounted, a shielded cable may need to be used to reduce the electrical noise and unnecessary electromagnetic emissions caused by the distance of the antenna from controller 64.

Remotely mounting the antenna, in some cases, may be an advantage from a cost standpoint if some or all of the controller components may be integrated into the existing printer electronics. For example, the controller chip may be integrated into the existing printer ASIC for little or no cost added, lowering the cost of the printer transceiver function.

As shown in FIGS. 1, 2, and 4, antenna 62 may be positioned in a substantially horizontal orientation on an upper panel 11 of printer 10. It is understood that antenna 62 and/or controller 64 (i.e., RF linking device 60) may be disposed in a variety of positions/places on or within printer 10 without departing from the spirit and scope of the present invention. In the exemplary embodiment, carriage 12 may move ink tank 40 to a position that aligns ink tank antenna 52 (and/or RF linking device 50) with printer antenna 62 (and/or RF linking device 60) to form an RF link between ink tank 40 and printer 10.

Such an alignment of the two RF antennas may comprise a variety of configurations, including but not limited to the two RF antennas being substantially parallel or perpendicular to one another. In the exemplary embodiment shown in FIGS. 1, 2, and 4, carriage 12 may move ink tank 40 such that printer antenna 62 is under and substantially perpendicular to ink tank antenna 52 at an angle α. The substantially perpendicular angle α may range between about 45 degrees and about 90 degrees. In order to optimize the RF link between the substantially perpendicular antennas 52 and 62, carriage 12 moves ink tank 40 to a position such that antenna 52 (i.e., loop 53) of RF device 50 is substantially under the periphery of antenna 62 (i.e., loop 63) of RF device 60. When antenna 52 is under the periphery of antenna 62, it is in an optimal linking region 70 for the perpendicular RF linking devices as shown in FIG. 4.

Alternatively and as described above, RF linking device 50 may be positioned along housing 40 such that antenna 52 is in a substantially parallel orientation (not shown) relative to antenna 62 of the printer. For example, RF linking device 50 may be positioned along a substantially horizontal face (e.g., face 46e or face 46f) such that it is substantially parallel to antenna 62 positioned on upper panel 11 or lower panel 13 of printer 10, respectively. In another exemplary embodiment, RF linking device 50 may be positioned along a substantially vertical face (e.g., 46a, 46b, 46c, or 46d) such that antenna 52 would be substantially parallel with antenna 62, which is positioned on a substantially horizontal panel (e.g., side panel 15 or side panel 17) of printer 10. Carriage 12 of printer 10 may then move ink tank 40 into the optimal linking region (not shown) and be in the optimal orientation (e.g., parallel to printer antenna 62).

Accordingly, while some of the alternative embodiments of the present invention have been discussed specifically, other embodiments will be apparent or relatively easily developed by those of ordinary skill in the art. Accordingly, this invention is intended to embrace all alternatives, modifications and variations that have been discussed herein, and others that fall within the spirit and broad scope of the claims.

What is claimed is:

1. An ink tank for an inkjet printing device, comprising:
a housing configured to connect to an inkjet printing device, wherein said housing comprises a plurality of faces;
a reservoir for containing ink disposed within said housing; and
a first RF linking device positioned along one of the largest faces of said plurality of faces.

2. The ink tank according to claim 1, wherein said first RF linking device is a RFID tag.

3. The ink tank according to claim 1, wherein said first RF linking device comprises a first antenna, wherein said first antenna is positioned along said largest face and wherein said first antenna is configured to maximize the area of said first antenna.

4. The ink tank according to claim 3, further comprising memory and a controller in electrical communication with said first RF linking device.

5. The ink tank according to claim 3, wherein said housing is configured to connect to a movable carriage of said inkjet printing device, and wherein said carriage is configured to move said ink tank such that said first antenna is positioned within an optimal linking region of a second antenna positioned on said inkjet printing device to form an RF link between said ink tank and inkjet printing device to permit information and signals to be transferred therebetween.

6. The ink tank according to claim 5, wherein said first antenna is positioned under and substantially perpendicular with said second antenna of said inkjet printing device.

7. The ink tank according to claim 6, wherein said first antenna is disposed in a substantially vertical orientation and said second antenna is disposed in a substantially horizontal orientation.

8. The ink tank according to claim 6, wherein said first antenna and said second antenna are substantially parallel to one another.

9. A system for exchanging information between a consumable item and a printing device, comprising:
a consumable item comprising a first RF linking device positioned along a substantially vertical face of said consumable item;
a printing device comprising a second RF linking device disposed along said printing device; and
wherein said consumable item is detachably connected to said printing device.

10. The system according to claim 9, wherein said first and second RF linking devices are substantially perpendicular to one another.

11. The system according to claim 9, wherein said first RF linking device is positioned within an optimal linking region of said second RF linking device to form an RF link between said ink tank and said printing device to permit information and signals to be transferred therebetween.

12. The system according to claim 9, wherein said printing device comprises a movable carriage connected to said printing device, and wherein said ink tank is removably connected to said carriage.

13. The system according to claim 12, wherein said first RF linking device comprises a first antenna positioned along said substantially vertical face, and wherein said carriage is configured to move said ink tank such that said first antenna is positioned within said optimal linking region of said second RF linking device.

14. The system according to claim 9, wherein said first RF linking device includes a first antenna that is positioned along said face such that the area of said first antenna is maximized.

15. The system according to claim 14, wherein said face that said first RF linking device is positioned along is one of the largest faces of said ink tank.

16. The system according to claim 9, wherein said first RF linking device comprises a first antenna positioned along said face of said consumable item and said second RF linking device comprises a second antenna positioned along said printing device such that said first and second antennae are substantially parallel to one another.

17. The system according to claim 9, wherein said first RF linking device is an RFID tag.

18. A method of linking a consumable item with a printer using RF, comprising
providing a consumable item for a printer; and
placing a RFID tag having a first antenna along a face of said consumable item such that the area of said first antenna is maximized.

19. The method according to claim 18, further comprising
providing a printer having a RF linking device positioned along said printer, said RF linking device comprising a second antenna;
connecting said consumable item into said printer such that said first antenna is substantially perpendicular to said second antenna.

20. The method according to claim 19, further comprising
positioning said first antenna within an optimal linking region of said RF linking device.
